(19) United States
(12) Patent Application Publication
(10) Pub. No.: US 2026/0273370 A1
(43) Pub. Date: Sep. 17, 2026

(54) A SYSTEM FOR GAMIFYING A PUNCHING BAG TRAINING SESSION

(71) Applicant: BHT, UNIPESSOAL, Lda., São Francisco (PT)

(72) Inventors: Mauro ANGELO JORGE FROTA, Leiria (PT); Pedro Jorge RATAO BATISTA BARATA, Leiria (PT)

(21) Appl. No.: 19/472,682

(22) PCT Filed: Jan. 5, 2024
(86) PCT No.: PCT/IB2024/050106

§ 371 Date: Oct. 5, 2025

(30) Foreign Application Priority Data
Apr. 6, 2023 (PT) 118594
Jan. 4, 2024 (PT) 119196

(51) Int. Cl. A63B 69/32; A63B 24/00; A63B 69/22; A63B 71/06

(52) U.S. Cl. CPC A63B 69/32; A63B 24/0062; A63B 69/22; A63B 71/0616; A63B 2220/05; A63B 2220/53; A63B 2220/806; A63B 2220/833; A63B 2225/02

(57) ABSTRACT

The object of the present application relates to a gamified-based system able to create a gamified training environment when a player (3) is performing a punching bag training session. For that purpose, the system comprises a central processing unit (1) that are communicably coupled to a plurality of electronic punching bags (2), each punching bag comprising detection means (2.1, 2.2) adapted to collect the bag's weight data and the impact data caused by a player's strike, which is then communicated to a calibration module (1.1) and a performance module (1.2), in order to determine the player's performance data. This approach allows to determine a player's performance in a uniform way, so that a direct comparison with other players, that may be executing the same training session, be performed reliably. Said player's performance data can be accessed via a player interface module (1.3).

### FIELD OF THE APPLICATION

The present application generally relates to systems for training and evaluating players performing a training session. More specifically, the present application is directed to systems providing training and evaluation platforms able to create a competitive, gamified training activities.

### PRIOR ART

Some of the challenges people face when trying to workout at home is the lack of motivation, monitoring and tracking of their performance and technique along with the well-meant competition when working against other “players” at the gym.

With regard to combat sports, it is common to resort to inertial measurement units composed of accelerometers and gyroscopes, for performing the acquisition of data that allow to detect in real time not only the impacts, but also determine a set of characteristics used to later analyse the performance of the player's impacts.

The incorporation of such sensors into the training activity can follow two different approaches: while some introduce the sensors into accessories used as boxing gloves, handles or leg/ankle bands depending on the type of martial art to be practiced, others incorporate the sensors in the punching bag. Notwithstanding, both approaches have limitations: If the sensors are placed on the accessories, such as handles, they can only detect impacts on the wrist, and any blow of another part of the body is not detectable. On the other hand, if the sensors are embedded in the punching bag, in theoretical terms it would be possible to detect any type of impact, be it punches, elbows or kicks. However, the results to be obtained are highly dependent on the configuration of the system (punching bag and sensors), since there are many factors that greatly affect the sensors reading, such as the dimension and weight of the punching bag, the length of the current anchoring to support the bag in the air, or the location inside the bag where the sensors are installed. Thus, training with such sensory device placed in identical bags, but with slightly different sensor installations or in bags with a different configuration will lead to different results: In fact, systems using this approach have a typical margin of error between 10-15% and its accuracy varies from bag to bag based on their configuration and/or weight.

Additionally, all these approaches calculate the strength/intensity of each impact through their own proprietary metrics (for example, that takes into account the speed of impact and acceleration of the handle/glove before impact), making it impossible to compare the impacts of players with the average strength values of amateur athletes and martial arts professionals, whose impact forces in units such as Joule and Newton are known, or comparing results of players using other devices.

Given the technical limitations of the existing solutions, it is not possible to monitor, track and compare player's performances in a reliable manner.

It is therefore necessary to develop a system that, based on the detection of impacts produced by a player, is able to determine his performance in a uniform way, so that a direct comparison with other players can be performed reliably.

The present solution intended to innovatively overcome such issues.

### SUMMARY OF THE APPLICATION

It is therefore an object of the present application a system for gamifying a punching bag training session.

The system comprises one or more electronic punching bags, each of them being assigned to a player and a central processing unit that is communicably coupled to the punching bags. Each punching bag has a weight measurement module and an impact detection module that are adapted to extract information from a player's strike inflicted on the bag, that is processed by the central processing unit in order to determine the player's performance based at least on the weight calibration data of the assigned bag (2) and the impact data resulting from at least one player's strike.

As it is a system implemented over a communications network, it thus becomes possible to monitor the performance of each player assigned to an electronic punching bag and perform comparisons between players in a reliable manner.

In an advantageous configuration of the system, the central processing unit comprises a training-storage module that stores training data including at least one training session to be performed by a player on the assigned electronic punching bag. In this way, the comparison between players' performances can be made more fairly, since it will be based on the execution of the same training session, which is defined by a predetermined sequence of player actions.

In another advantageous mode of the system, the player interface module of the central processing unit comprises a web-based application that is accessible by the plurality of players through a network communication via one or more devices that can be selected from a group consisting of a smart TV, a smartphone, a tablet or a laptop.

Each player will thus be able, in a simple way, to have access to his performance

### DESCRIPTION OF FIGURES

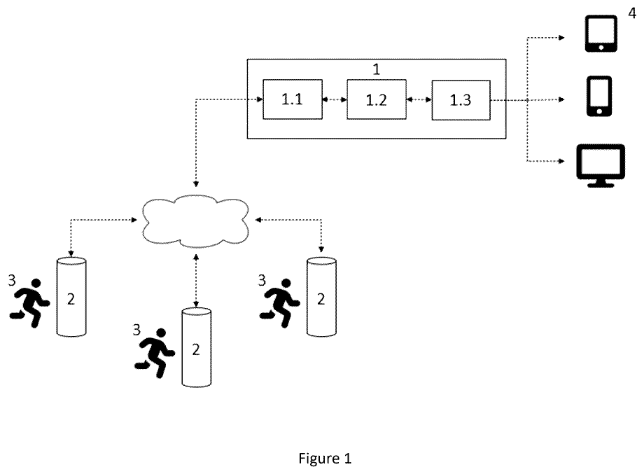

FIG. 1—representation of an embodiment of the system object of the present application; the reference signs represent:
1—central processing unit;
1.1—calibration module;
1.2—performance determination module;
1.3—player interface module;
2—electronic punching bag;
3—player;
4—player interface devices.

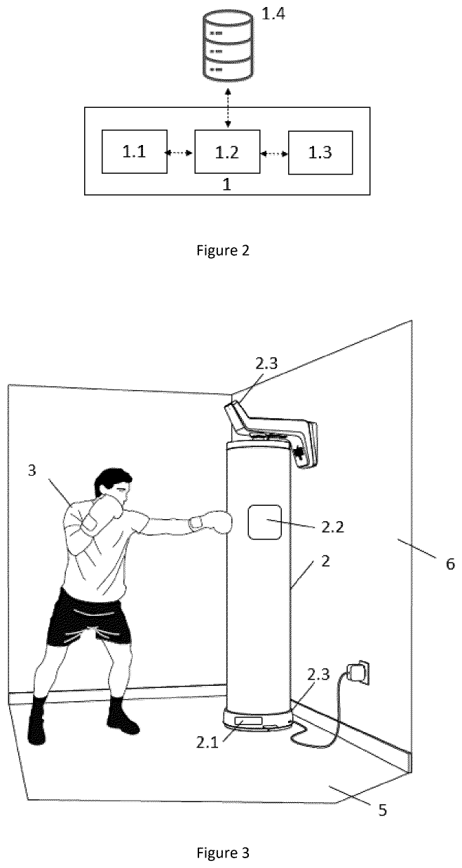

FIG. 2—representation of an embodiment of the central processing unit, wherein the reference signs represent:
1—central processing unit;
1.1—calibration module;
1.2—performance determination module;
1.3—player interface module;
1.4—training-storage module.

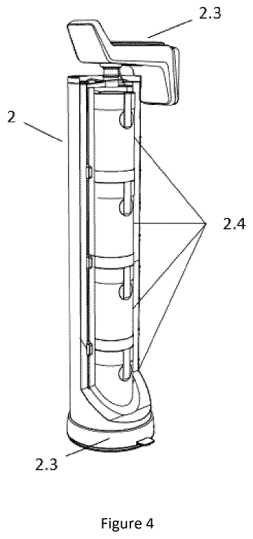

FIG. 3—representation of the electronic punching bag anchored to two perpendicular surfaces; the reference signs represent:
2—electronic punching bag;
2.1—weight measurement module, installed in the base module of the anchoring unit;
2.2—impact detection module;
2.3—anchoring unit;
3—player
5—first supporting surface;
6—second supporting surface.

FIG. 4—representation of the inner water bladders making up the core of the electronic punching bag; the reference signs represent:
2—electronic punching bag;
2.3—anchoring unit;
2.4—water bladder.

### DETAILED DESCRIPTION

The more general and advantageous configurations of the system are described in the Summary of the application. Such configurations are detailed below in accordance with other advantageous and/or preferred embodiments of implementation of the system now developed.

The present application relates to system for gamifying a punching bag training session.

Such a system enables monitoring and tracking players' performances in a reliable manner. As a consequence, based on the detection of impacts produced by a player, the system is able to determine the player's performance in a uniform way so that a direct comparison with other players can be performed reliably.

For that purpose, the system communicably couples a central processing unit (1) and one or more electronic punching bags (2). The system then provides the connection between these two elements, which can be established through any state-of-the-art communication network, wired or wireless.

Each electronic punching bag (2) of the system is assigned to a player (3) intended for practicing a training session to be monitored. In the context of the present application, it is understood that a player (3) can only have one bag (2) assigned to him per training session. This association between player (3) and bag (2) can be performed through state-of-the-art authentication mechanisms established between the central processing unit (1) and the player (3).

An electronic punching bag (2) is comprised by a weight measurement module (2.1) and by an impact detection module (2.2).

The weight measurement module (2.1) is configured to periodically measure the weight of the bag (2) and to communicate weight measurement data to the central processing unit (1).

In its turn, the impact detection module (2.2) is configured to detect an impact caused by a player's strike on the bag (2), to generate a correspondent impact data, and to communicate said impact data to the central processing unit (1).

In the context of the present application, impact data may relate to a type of strike, an intensity value of the impact, and a location of the impact on the bag (2). The central processing unit (1) comprises processing capacity configured to implement the following modules: a calibration module (1.1), a performance determination module (1.2) and a player interface module (1.3).

The calibration module (1.1) is configured to generate a weight calibration data for each bag (2), based on the weight measurement data extracted from the weight measurement module (2.1) of the respective bag (2).

The performance determination module (1.2) is configured to determine a player's performance data based at least on the weight calibration data of the assigned bag (2) and the impact data resulting from at least one player's strike inflicted on the bag (2).

The player Interface module (1.3) is communicably coupled to at least the performance determination module (1.2) and is adapted to provide a gamified training platform adapted to allow a player (3) to access player's performance data.

In one embodiment of the system, the central processing unit (1) further comprises a training-storage module (1.4).

Said module (1.4) is adapted to store training data and player data associated with the players (3) having an assigned bag (2).

More particularly, the training data relates to training sessions to be performed by players (3) on the respective assigned electronic punching bag (2). Each training session includes a sequence of predetermined player actions, including, for example at least a player strike of at least one type, to be inflicted on specific locations on the bag (2), at predefine instants of time, during a training session's duration period. Player data may include historical activity data of a player (3), the historical activity data including data pertaining to one or more training sessions previously performed by the player (3) through the gamified training platform, including information related to the player's performance data.

In order to allow a player (3) to access training data and/or player data via gamified training platform, the player interface module (1.3) is further communicably coupled to the training-storage module (1.4).

In another embodiment of the system, the player interface module (1.3) of the central processing unit (1) comprises a web-based application accessible by the plurality of players (3) through a network communication via one or more devices (4) selected from a group consisting of a smart TV, a smartphone, a tablet or a laptop.

In another embodiment of the system, each electronic punching bag (2) is further assigned to a training session of the training-storage module (1.4), and it further comprises a guiding module operatively coupled to the gamified training platform to allow access to said training session. The guiding module may be provided with display means and/or lighting means of a LED type.

In this way, the system provides an interactive mechanism to guide the player (3) through the training session.

In another embodiment of the system, the performance determination module (1.2) of the central processing unit (1) comprises a rule engine.

Said rule engine is configured to define one or more rules and at least one score value for accomplishment of each of said rules. More particularly, the rule engine is operable to process at least the weight calibration data and the impact data resulting from at least one player's strike on the assigned bag (2) based on said rules, in order to determine a total score value defining the player's performance data.

Even more particularly, the rules of the rule engine may be programmed to validate the impact data generated by a bag's impact detection module (2.2) depending on a pre-set weight calibration data's threshold parameter, and to calculate the intensity of the impact caused by the player's strike according to an international standard measurement unit. In this way, it is possible to compare impact data of players with the average values obtained from amateur athletes and martial arts professionals, whose impact data values in units such as Joule and Newton are known, thus allowing the player (3) to obtain a measurable metric in relation to his training level.

Base on that, the rules of the rule engine are further programmed to, upon validating a type of strike inflicted by a player (3) on the bag (2), to attribute a correspondent score value according to the type of strike inflicted by the player, its intensity and the location within the bags (2) body. In order to attribute a score according to the type of strike, the rule engine is further communicably coupled to a strike-storage module that stores one or more predetermined admissible strikes.

In another embodiment of the system, the rule engine is communicably coupled to the training-storage module (1.4), and the rules of the rule engine are programmed to determine a player's level of accuracy in performing a training session, by verifying if the sequence of predetermined player's strikes of said training session matches the impact data associated with a sequence of player's strikes being inflicted on the assigned bag (2). Consequently, the rules of the rule engine are further programmed to attribute a score value to the player's training session depending on the determined player's level of accuracy.

In another embodiment of the system, the rules of the rule engine are programmed to group electronic punching bags (2) assigned to a same training session and the gamified training platform is configured to provide a training session's ranking list with the respective player's total score value.

In this way it is possible to establish a performance ranking of players who have performed the same training session, and have immediate access to this information.

In another embodiment of the system, the rules of the rule engine are programmed to determine a player's profile parameter selected from a group consisting of a level of expertise, a player's height and a player's weight, and to calculate the total score value defining the player's performance data based on the player's profile parameter.

In another embodiment of the system, the electronic punching bag (2) comprises an elongated body arranged along a vertical axis and an anchoring unit (2.3). The elongated body may comprise at least one inner water bladder (2.4) arranged along the longitudinal axis of the body and defining the body's core part. The elongated body may be comprised by 4 water bladders (2.4) stacked on top of each other, having each bladder (2.4) a capacity of 20-liter.

In this way it is guaranteed that the bag (2) is a robust body and at the same time with deforming capacity, so that it can make the player's training experience more real.

The anchoring unit (2.3) comprises a base module adapted to vertically support the bag (2) on a first horizontal supporting surface (5). More particularly, the weight measurement module (2.1) is installed in the base module and it may be comprised by at least one load cell, preferably it is comprised by six load cells.

The anchoring unit (2.3) further comprises an attachment module configured to connect the bag (2) to a second supporting surface (6). Preferably, said second supporting surface (6) is perpendicular to the first supporting surface (5).

The base module and the attachment module are operable to block the bag's displacement over a horizontal plane, parallel to the first horizontal supporting surface (5).

Consequently, the impact detected by the impact detection module (2.2) is no longer polluted by the reaction movement of the bag (2) following the user's strike, which is thus restricted. As such, impact data determined by the impact detection module (2.2) is obtained more accurately, allowing to reduce the margin of error associated with this type of measurement.

In another embodiment of the system, the impact detection module (2.2) of the bag (2) comprises an array of inertial measurement sensors, a camera device and a processor-based apparatus.

The sensors are dispersed throughout the bag (2), preferably in an inner layer and are configured to detect an impact on the bag (2) caused by a strike and to determine the intensity of said strike.

The camera device is adapted to generate a video record data of a player's training session and the processor-based apparatus is operatively coupled to the array of sensors and to the camera device and is configured to:
determine the location of the strike based on the sensorial data collected by the sensors and the video record data generated by the camera device; and to
determine the type of strike by processing the video record data generated by the camera device using a pose detection model.

1. A system for gamifying a punching bag training session comprising:
A central processing unit (1); and
One or more electronic punching bags (2), communicably coupled to the central processing unit (1);
wherein, each electronic punching bag (2) being assigned to a player (3) executing a training session, and comprises:
A weight measurement module (2.1) configured to periodically measure the weight of the bag (2) and to communicate weight measurement data to the central processing unit (1); and
An impact detection module (2.2) configured to detect an impact caused by a player's strike on the bag (2), to generate a correspondent impact data, and to communicate said impact data to the central processing unit (1); the impact data relating to a type of strike, an intensity of the impact, and a location of the impact on the bag (2);
the central processing unit (1) comprises:
A calibration module (1.1) configured to generate a weight calibration data for each bag (2), based on the weight measurement data from the respective weight measurement module (2.1);
A performance determination module (1.2) configured to determine a player's performance data based at least on the weight calibration data of the assigned bag (2) and the impact data resulting from at least one player's strike;
A player Interface module (1.3) communicably coupled to at least the performance determination module (1.2) and adapted to provide a gamified training platform adapted to allow a player (3) to access player's performance data.

2. The system according to claim 1 wherein the central processing unit (1) further comprises a training-storage module (1.4) that stores:
training data including at least one training session to be performed by at least one player (3) on the assigned electronic punching bag (2); each training session including a sequence of predetermined player actions; a player action including:
at least a player strike of at least one type, to be inflicted on specific locations on the bag (2), at predefine instants of time, during a training session's duration period;
player data associated with a plurality of player's (3) having an assigned bag (2);
and wherein, the player interface module (1.3) being further communicably coupled to the training-storage module (1.4) and
the gamified training platform is further adapted to allow a player (3) to access training data and/or player data.

3. The system according to claim 2, wherein the player data includes historical activity data of a player (3), the historical activity data including data pertaining to one or more training sessions previously performed by the player (3) through the gamified training platform, including information related to the player's performance data.

4. The system according to claim 1, wherein the player interface module (1.3) comprises a web-based application accessible by the plurality of players (3) through a network communication via one or more devices selected from a group consisting of a smart TV, a smartphone, a tablet or a laptop.

5. The system according to claim 2, wherein each electronic punching bag (2) is further assigned to a training session of the training-storage module (1.4), and it further comprises a guiding module operatively coupled to the gamified training platform to allow access to said training session; the guiding module being provided with display means and/or lighting means; optionally the guiding means being of a LED type.

6. The system according to claim 1, wherein the performance determination module (1.2) comprises a rule engine configured to define one or more rules and at least one score value for accomplishment of each of said rules; the rule engine being operable to process at least the weight calibration data and the impact data resulting from at least one player's strike on the assigned bag (2) based on said rules, in order to determine a total score value defining the player's performance data.

7. The system according to claim 6, wherein the rules of the rule engine are programmed to:
validate the impact data generated by a bag's impact detection module (2.2) depending on a pre-set weight calibration data's threshold parameter;
calculate the intensity of the impact caused by the player's strike according to an international standard measurement unit.

8. The system according to claims 6, wherein, the rules of the rule engine are programmed to:
validate a type of strike inflicted by a player (3) on the bag (2) and attribute a correspondent score value; the rule engine being further communicably coupled to a strike-storage module that stores one or more predetermined admissible strikes;
attribute a score value depending on the intensity of the impact caused by the player's strike;
attribute a score value dependent on the location of the impact caused by the player's strike.

9. System according to claims 2, wherein the rule engine is communicably coupled to the training-storage module (1.4), and the rules of the rule engine are programmed to:
determine a player's level of accuracy in performing a training session by verifying if the sequence of predetermined player's strikes of said training session matches the impact data associated with a sequence of player's strikes being inflicted on the assigned bag (2); and to attribute a score value depending on the determined player's level of accuracy.

10. System according to claims 9, wherein the rules of the rule engine are programmed to group electronic punching bags (2) assigned to a same training session;
and the gamified training platform is configured to provide a training session's ranking list with the respective player's total score value.

11. System according to claim wherein the rules of the rule engine are programmed to:
determine a player's profile parameter being selected from a group consisting of a level of expertise, a player's height and a player's weight;
calculate the total score value defining the player's performance data based on the player's profile parameter.

12. The system according to claim 1, wherein the electronic punching bag (2) comprises:
an elongated body arranged along a vertical axis;
an anchoring unit (2.3) comprising a base module adapted to vertically support the bag on a first horizontal supporting surface (5), and wherein, the weight measurement module (2.1) is installed in the base module;
optionally, the weight measurement module (2.1) comprises at least one load cell; optionally, the weight measurement module (2.1) comprises six load cells.

13. The system according to claim 12, wherein the anchoring unit (2.3) of the electronic punching bag (2) further comprises an attachment module configured to connect the bag to a second supporting surface (6); the base module and the attachment module being operable to block the bag's displacement over a horizontal plane, parallel to the first horizontal supporting surface (5); optionally, the second supporting surface (6) is perpendicular to the first supporting surface (5).

14. The system according to claims 12, wherein the elongated body comprises at least one inner water bladder (2.4) arranged along the longitudinal axis of the body and defining the body's core part; optionally, the elongated body is comprised by 4 water bladders (2.4) stacked on top of each other; optionally, each bladder (2.4) has a capacity of 20-liter.

15. The system according to claim 1, wherein the impact detection module (2.2) comprises:
an array of inertial measurement sensors configured to detect an impact on the bag (2) caused by a strike and to determine the intensity of said strike;
a camera device adapted to generate a video record data of a player's training session; and
a processor-based apparatus operatively coupled to the array of sensors and to the camera device and configured to:
determine the location of the strike based on the sensorial data collected by the sensors and the video record data generated by the camera device; and to
determine the type of strike by processing the video record data generated by the camera device using a pose detection model.
